(19) United States
(12) Patent Application Publication
(10) Pub. No.: US 2007/0221586 A1
(43) Pub. Date: Sep. 27, 2007

(54) High pressure oil removing filter

(76) Inventor: John C. Ruprecht, North Oaks, MN (US)

Correspondence Address: JAMES D. WELCH, 10328 PINEHURST AVE., OMAHA, NE, 68124, US

(21) Appl. No.: 11/452,012

(22) Filed: Jun. 14, 2006

Related U.S. Application Data
(60) Provisional application No. 60/694,093, filed on Jun. 27, 2005.

(51) Int. Cl. C02F 1/00

(52) U.S. Cl. 210/799

(57) ABSTRACT

A system for entering a mixture of oil and water thereinto which develops a high back pressure, and via causing said mixture to pass through a mixture of polypropylene and plastic beads in an upper approximately ⅔ thereof, and polypropylene in the lower approximately ⅓ thereof, providing water at an outlet from which the oil has been removed.

This Application Claims benefit Provisional Application Ser. No. 60/694,093 Filed Jun. 27, 2005.

### TECHNICAL FIELD

The presently disclosed invention relates to systems for removing oil from liquids, and more particularly to a system for entering a mixture of oil and water thereinto which develops a high back pressure, and via causing said mixture to pass through a mixture of polypropylene and plastic beads in an upper majority thereof, and polypropylene in the lower minority thereof, providing water at an outlet from which the oil has been removed.

### BACKGROUND

It is known to remove oil from liquids such as water using filtering means.

With the present invention in mind, a Search of Patents was conducted and identified:
U.S. Pat. No. 6,015,494 to Siverling et al. describes a oil/water separator using a polyolefin sheets;
U.S. Pat. No. 4,913,815 to Shulda describes a concentric dual bag filer having an inlet and outlet, and polypropylene filter means in a dual bag;
U.S. Pat. No. 4,839,040 to Alm describes a filter apparatus for purifying oil contaminated water that has cylindrical outer and inner shells;
U.S. Pat. No. 4,282,097 to Kuepper et al., describes a method of separating oil and water through coalescer tubes made from water permeable fibers. Use of polypropylene is mentioned;
U.S. Pat. No. 3,830,371 to Garcia describes using polypropylene in an apparatus for separating oil and water by passage through a cylindrical shaped space;
U.S. Pat. No. 3,617,548 to Willihnganz describes a method for separating oil and water by passage through a polypropylene mesh. The discussion regarding the 371 patent is generally applicable;
Pat. RE 31,047 to Ross describes a method for separating oil from water by passage through a fiber web involving use of polypropylene.

Need remains for a system for entering a mixture of oil and water thereinto which develops a high back pressure, and which releases water which is separated from the oil. Preferably the system should not require use of polyolefin sheets or bags or fiber webbing, should provide a large mass of oil removing material rather than use limited inner and/or an outer shell(s) of a filter to do so, and should not separate oil and water through clogging prone coalescer tubes made from water permeable fibers using polypropylene. In addition, it should provide two different filtering material layers to remove the oil from the water to minimize clogging via the formation of a “hockey puck” of sorts in the oil removing material(s).

### DISCLOSURE OF THE INVENTION

The present invention provides that the upper majority, (eg. ⅔), of the thereof have a media comprised of a combined mixture of plastic beads packed to a functional compaction level in a cylinder, (eg. an 8×36 inch cylinder). At the bottom of said cylinder there is an “end bell”, exemplified as comprising a 4 inch band of holes, optionally in a specific pattern and of a functional size. The top of the present invention is sealed with a top cap which has an exemplary 1 inch diameter hole in the center thereof through which, in use, oily water is pumped thereinto under pressure and, preferably at a functional pressure pulse rate. The result is that the present invention media adsorbs the oil from the water. It is noted that pulse action has been found to allow the present invention media to expand and have required contact time with the oily water to remove substantially all oil present. The pump increases the discharge pressure, which is the inlet pressure less a drop resulting across oil absorbed in present invention polypropylene media. The plastic beads mixed with the polypropylene ensure that oily water will continue to flow through the present invention. If plastic particulates are not present it has been found that the separated oil will collect in the polypropylene and create a blockage which prevents further flow of oily water therethrough. The lower minority, (eg. ⅓), of the present invention is 100% polypropylene packet to a functional density to effectively remove any trace oil from the oily water that was not captured in the top of the present invention. Clean water then discharges in a radial flow via the band of perforation (holes) located near the bottom end bell of the present invention housing.

Re-itterating, the presently disclosed invention is a filter for separating oil from water. The preferred embodiment is comprised of an outer cylinder having input and output means present thereon, for entering a mixture of water and oil and exiting water. Said outer cylinder is closed on the sides and on the bottom thereof and has means for securing an inner cylinder/colander therewithin which is filled with a mixture of polypropylene and plastic beads in the upper approximately ⅔ thereof, and polypropylene in the lower approximately ⅓ thereof. Said filter has permeable means at the bottom thereof. In use a said top is secured to said outer cylinder and a mixture of oil and water is entered to the input means, flows through said mixture of polypropylene and plastic beads in the upper approximately ⅔ thereof, and polypropylene in the lower approximately ⅓ thereof, and through said permeable means at the bottom of the inner cylinder/colander. Water exits through said output means of the outer cylinder, and oil is accumulated in the polypropylene and plastic beads.

The present invention will be better understood by a reading of the Detailed description Section of this Disclosure with reference to the Drawings.

### BRIEF DESCRIPTION OF THE DRAWINGS

FIG. 1 shows a partially constructed side elevational cross-sectional taken at b-b in FIG. 2 of the presently disclosed invention.

FIG. 2 shows a top secured in place to an Outer Cylinder and Inner Cylinder/Colander.

FIG. 3 shows a top view of the top identified in FIG. 2.

### DETAILED DESCRIPTION

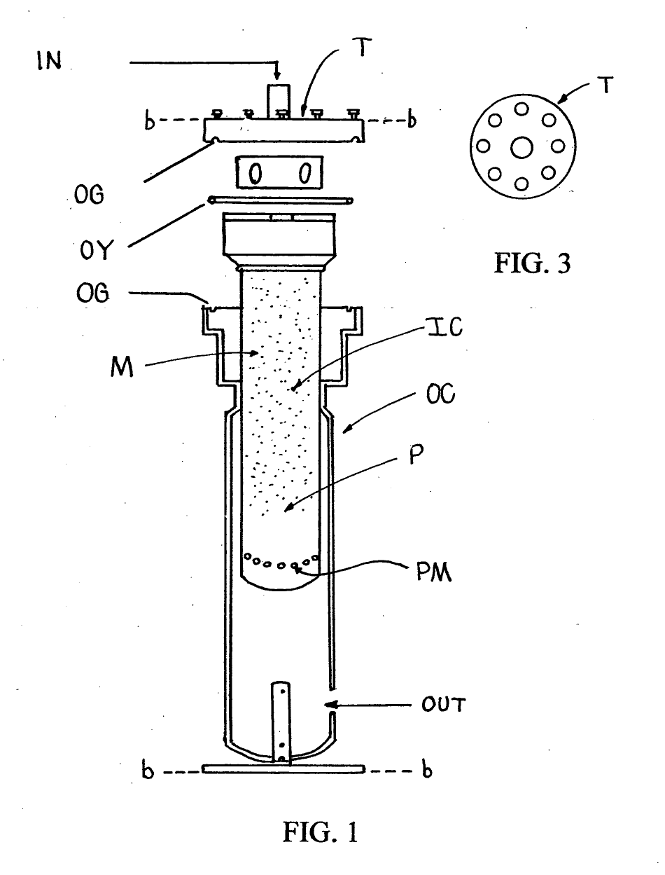

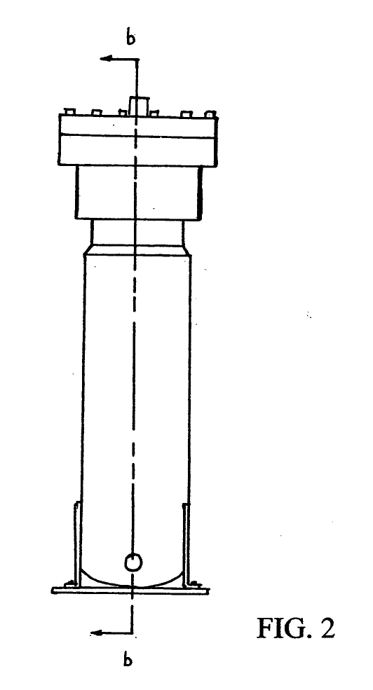

FIG. 1 shows a partially constructed side elevational view of the presently disclosed invention system. Note a Top (T), an Inner Cylinder/Colander (IC), and an Outer Cylinder (OC) are present. The Inner Cylinder/Colander positions in the Outer Cylinder, and the Top (T) secures the Inner Cylinder/Colander (IC) in place. There is an “O” ring present between the Top (T) and the upper aspect of the Outer Cylinder (OC). Also shown are “O” ring receiving grooves (OG). Note that the upper portion of the Inner Cylinder/Colander (IC) is shaped to fit in a reception region therefore in the top of the Outer Cylinder (CO), and that when the Top (T) is secured to the Outer Cylinder (C), as shown in FIG. 2, said top of the Inner Cylinder/Colander (IC) is secured in place.

Note also the indication of a mixture (M) of Polypropylene and Plastic Beads in the upper approximately ⅔ of the Inner Cylinder/Colander, and Polypropylene (P) in the lower approximately ⅓ thereof, and Permeable Means (PM) at the bottom thereof. The plastic beads are typically ⅛ to ¼ inch in diameter. FIG. 2 shows the system with the Top secured to the Outer Cylinder (OC), and FIG. 3 shows a Top view of the Top (T).

Having hereby disclosed the subject matter of the present invention, it should be obvious that many modifications, substitutions, and variations of the present invention are possible in view of the teachings. It is therefore to be understood that the invention may be practiced other than as specifically described, and should be limited in its breadth and scope only by the Claims.

1. A filter for separating oil from water comprising:
an outer enclosure having input and output means present thereon for entering a mixture of water and oil and exiting water, said outer enclosure being closed on the sides and on the lower extent thereof, said outer enclosure having means for securing a top thereto;
a top;
an inner colander which is filled with a sequence of a mixture of polypropylene and plastic beads in the upper majority thereof, and polypropylene in the lower minority thereof, and permeable means at the bottom thereof, said plastic beads comprising a means for ensuring that oily water continues to flow through said mixture of polypropylene and plastic beads, by preventing oil which is separated from water thereby, from forming a blockage thereto;
such that in use a said top is secured to said outer enclosure and a mixture of oil and water is entered to the input means, flows through said mixture of polypropylene and plastic beads and polypropylene, then through said permeable means at the bottom of the inner colander before water exits through said output means of the outer enclosure.

2. A filter as in claim 1, wherein the terminology “upper majority” of the colander represents approximately ⅔ of the total volume thereof, and the terminology “lower minority” of the colander represents approximately ⅓ of the total volume thereof.

3. A method of separating oil from water comprising:
a) providing a filter for separating oil from water comprising an outer enclosure having input and output means present thereon for entering a mixture of water and oil and exiting water, said outer enclosure being closed on the sides and on the bottom thereof, said outer enclosure having means for securing a top thereto;
a top;
an inner colander which is filled with a sequence of a mixture of polypropylene and plastic beads in the upper majority thereof, and polypropylene in the lower minority thereof, and permeable means at the bottom thereof, said plastic beads comprising a means for ensuring that oily water continues to flow through said mixture of polyproylene and plastic beads, by preventing oil which is separated from water thereby, from forming a blockage thereto;
such that in use a said top is secured to said outer enclosure and a mixture of oil and water is entered to the input means, flows through said mixture of polypropylene and plastic beads and polypropylene, and through said permeable means at the bottom of the inner colander before water exits through said output means of the outer enclosure;
b) entering a mixture of oil and water to the input means and collecting water from the output means.

4. A method as in claim 3, in which the mixture of oil and water is entered in a pulsed manner.

5. A filter for separating at least one additional component from water comprising:
an outer enclosure having input and output means present thereon for entering a mixture of water and at least one additional component and exiting water, said outer enclosure being closed on the sides and on the lower extent thereof, said outer enclosure having means for securing a top thereto;
a top;
an inner colander which is filled with a sequence of a mixture of polypropylene and plastic beads in the upper majority thereof, and polypropylene in the lower minority thereof, and permeable means at the bottom thereof, said plastic beads comprising a means for ensuring that oily water continues to flow through said mixture of polypropylene and plastic beads, by preventing oil which is separated from water thereby, from forming a blockage thereto;
such that in use a said top is secured to said outer enclosure and a mixture of said at least one additional component and water is entered to the input means, flows through said mixture of polypropylene and plastic beads and polypropylene, then through said permeable means at the bottom of the inner colander before water exits through said output means of the outer enclosure.

6. A filter and in claim 5, wherein the terminology “upper majority” of the colander represents approximately ⅔of the total volume thereof, and the terminology “lover minority” of the colander represents approximately ⅓of the total volume thereof.

7. A method of separating at least one additional component from water comprising:
a) providing a filter for separating at least one additional component from water comprising an outer enclosure having input and output means present thereon for entering a mixture of water and at least one additional component and exiting water, said outer enclosure being closed on the sides and on the bottom thereof, said outer enclosure having means for securing a top thereto;
a top;
an inner colander which is filled with a sequence of a mixture of polypropylene and plastic beads in the upper majority thereof, and polypropylene in the lover minority thereof, and permeable means at the bottom thereof, said plastic beads comprising a means for ensuring that oily water continues to flow through said mixture of polypropylene and plastic beads, by preventing oil which is separated from water thereby, from forming a blockage thereto;
such that in use a said top is secured to said outer enclosure and a mixture of at least one additional component and water is entered to the input means, flows through said mixture of polypropylene and plastic beads and polypropylene, and through said permeable means at the bottom of the inner colander before water exits through said output means of the outer enclosure;
b) entering a mixture of said at least one additional component and water to the input means and collecting water from the output means.

8. A method as in claim 7, in which the mixture of said at least one additional component and water is entered in a pulsed manner.

9. A filter as in claim 1, in which said enclosure and said colander are cylindrical in shape.

10. A method as in claim 3, in which said provided enclosure and said provided colander are cylindrical in shape.

11. A filter as in claim 5, in which said enclosure and said colander are cylindrical in shape.

12. A method as in claim 7, in which said provided enclosure and said provided colander are cylindrical in shape.
